(19) United States
(12) Patent Application Publication
(10) Pub. No.: US 2025/0344200 A1
(43) Pub. Date: Nov. 6, 2025

(54) JOINT SEMI-PERSISTENT SCHEDULING CONFIGURATION

(71) Applicant: QUALCOMM Incorporated, San Diego, CA (US)

(72) Inventors: Iyab Issam SAKHNINI, San Diego, CA (US); Olufunmilola Omolade AWONIYI-OTERI, San Diego, CA (US); Tao LUO, San Diego, CA (US); Jelena DAMNJANOVIC, Del Mar, CA (US); Wanshi CHEN, San Diego, CA (US); Juan MONTOJO, San Diego, CA (US); Fang YUAN, Beijing (CN)

(21) Appl. No.: 18/868,989

(22) PCT Filed: Aug. 3, 2022
(86) PCT No.: PCT/CN2022/109912

§ 371 Date: Nov. 25, 2024

(51) Int. Cl. H04W 72/11

(52) U.S. Cl. CPC H04W 72/11

(57) ABSTRACT

Methods, systems, and devices for wireless communications are described. Some wireless communications systems may support joint semi-persistent scheduling (SPS) configuration. For example, a user equipment (UE) may receive a first control message indicating one or more uplink SPS configurations (e. g., configured grant (CG) configurations) and one or more downlink SPS configurations. Additionally, the UE may receive a second control message activating two or more SPS configurations of the one or more uplink SPS configurations, or the one or more downlink SPS configurations, or both. In some cases, the two or more SPS configurations that are activated may be associated with one or more component carriers (CCs). The UE may communicate with a network entity based on the two or more SPS configurations that are activated.

### CROSS REFERENCE

The present Application is a 371 national phase filing of International PCT Application No. PCT/CN2022/109912 by SAKHNINI et al., entitled “JOINT SEMI-PERSISTENT SCHEDULING CONFIGURATION,” filed Aug. 3, 2022, which is assigned to the assignee hereof, and which is expressly incorporated by reference in its entirety herein.

### FIELD OF TECHNOLOGY

The following relates to wireless communications, including joint semi-persistent scheduling (SPS) configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support joint semi-persistent scheduling (SPS) configurations. Generally, the techniques described herein may enable a network entity to activate two or more SPS configurations of a set of SPS configurations supported by a user equipment (UE). For example, a UE may receive a first control message indicating one or more uplink SPS configurations (e.g., configured grant (CG) configurations) and one or more downlink SPS configurations. Additionally, the UE may receive a second control message activating two or more SPS configurations of the one or more uplink SPS configurations, the one or more downlink SPS configurations, or both. In some cases, the two or more SPS configurations may be associated with one or more component carriers. The UE may communicate with a network entity based on the two or more SPS configurations activated by the second control message.

In some cases, the first control message may include an indication to skip one or more respective transmission occasions associated with the two or more SPS configurations, add one or more respective transmission occasions associated with the two or more SPS configurations, shift one or more respective time and/or frequency resources, change one or more respective beams associated with the two or more SPS configurations, or any combination thereof. Additionally, or alternatively, the UE may receive a third control message deactivating two or more SPS configurations of the one or more uplink SPS configurations, the one or more downlink SPS configurations, or both.

A method for wireless communications at a UE is described. The method may include receiving a first control message indicating one or more uplink SPS configurations and one or more downlink SPS configurations, receiving a second control message activating two or more SPS configurations of the one or more uplink SPS configurations, or the one or more downlink SPS configurations, or both, where the two or more SPS configurations that are activated are associated with one or more component carriers (CCs), and communicating with a network entity based on the two or more SPS configurations that are activated.

An apparatus for wireless communications at a UE is described. The apparatus may include a processor, memory coupled with the processor, and instructions stored in the memory. The instructions may be executable by the processor to cause the apparatus to receive a first control message indicating one or more uplink SPS configurations and one or more downlink SPS configurations, receive a second control message activating two or more SPS configurations of the one or more uplink SPS configurations, or the one or more downlink SPS configurations, or both, where the two or more SPS configurations that are activated are associated with one or more CCs, and communicate with a network entity based on the two or more SPS configurations that are activated.

Another apparatus for wireless communications at a UE is described. The apparatus may include means for receiving a first control message indicating one or more uplink SPS configurations and one or more downlink SPS configurations, means for receiving a second control message activating two or more SPS configurations of the one or more uplink SPS configurations, or the one or more downlink SPS configurations, or both, where the two or more SPS configurations that are activated are associated with one or more CCs, and means for communicating with a network entity based on the two or more SPS configurations that are activated.

A non-transitory computer-readable medium storing code for wireless communications at a UE is described. The code may include instructions executable by a processor to receive a first control message indicating one or more uplink SPS configurations and one or more downlink SPS configurations, receive a second control message activating two or more SPS configurations of the one or more uplink SPS configurations, or the one or more downlink SPS configurations, or both, where the two or more SPS configurations that are activated are associated with one or more CCs, and communicate with a network entity based on the two or more SPS configurations that are activated.

Some examples of the method, apparatuses, and non-transitory computer-readable medium described herein may further include operations, features, means, or instructions for receiving a third control message deactivating the two or more SPS configurations of the one or more uplink SPS configurations, or the one or more downlink SPS configurations, or both.

Some examples of the method, apparatuses, and non-transitory computer-readable medium described herein may further include operations, features, means, or instructions for skipping one or more respective transmission occasions associated with the two or more SPS configurations, where the one or more respective transmission occasions may be skipped based on a skipping indication included in the first control message.

Some examples of the method, apparatuses, and non-transitory computer- readable medium described herein may further include operations, features, means, or instructions for adding one or more respective transmission occasions associated with the two or more SPS configurations, where the one or more respective transmission occasions may be added based on an indication included in the first control message, and where the one or more respective transmission occasions may be used for communicating with the network entity.

Some examples of the method, apparatuses, and non-transitory computer-readable medium described herein may further include operations, features, means, or instructions for shifting one or more respective time resources, one or more respective frequency resources, or both, associated with the two or more SPS configurations, where the one or more respective time resources, the one or more respective frequency resources, or both may be shifted based on an indication included in the first control message, and where the one or more respective time resources, the one or more respective frequency resources, or both, that may be shifted may be used for communicating with the network entity.

Some examples of the method, apparatuses, and non-transitory computer-readable medium described herein may further include operations, features, means, or instructions for changing one or more respective beams associated with the two or more SPS configurations, where the one or more respective beams may be changed based on an indication included in the first control message, and where the one or more respective beams may be used for communicating with the network entity.

Some examples of the method, apparatuses, and non-transitory computer-readable medium described herein may further include operations, features, means, or instructions for transmitting a request message indicating a request for the two or more SPS configurations, where the first control message, the second control message, or both, may be based on the request message.

In some examples of the method, apparatuses, and non-transitory computer-readable medium described herein, a first SPS configuration and a second SPS configuration of the two or more SPS configurations may be associated with a same CC, the first control message indicating a first set of parameters for the first SPS configuration and a second set of parameters for the second SPS configuration.

In some examples of the method, apparatuses, and non-transitory computer-readable medium described herein, a first SPS configuration of the two or more SPS configurations may be associated with a first CC and a second SPS configuration of the two or more SPS configurations may be associated with a second CC different from the first CC, the first control message indicating a first set of parameters for the first SPS configuration and a second set of parameters for the second SPS configuration.

In some examples of the method, apparatuses, and non-transitory computer-readable medium described herein, communicating with the network entity may include operations, features, means, or instructions for communicating a same data stream via a set of multiple CCs using the two or more SPS configurations.

In some examples of the method, apparatuses, and non-transitory computer-readable medium described herein, communicating with the network entity may include operations, features, means, or instructions for communicating two or more data streams via a set of multiple CCs using the two or more SPS configurations, where each data stream of the two or more data streams may be associated with at least one CC of the set of multiple CCs.

In some examples of the method, apparatuses, and non-transitory computer-readable medium described herein, receiving the second control message may include operations, features, means, or instructions for receiving the second control message via a first CC of the one or more CCs and receiving the second control message via a second CC of the one or more CCs, the second CC being different from the first CC.

In some examples of the method, apparatuses, and non-transitory computer-readable medium described herein, the two or more SPS configurations may be activated based on a preconfigured time delay and the preconfigured time delay may be based on a capability of the UE, a quantity of the one or more CCs, frequencies associated with the one or more CCs, or any combination thereof.

In some examples of the method, apparatuses, and non-transitory computer-readable medium described herein, the first control message indicates a list of one or more CCs that may be associated with each SPS configuration of the two or more SPS configurations and CCs of each list of one or more components carriers may be used for communicating with the network entity using the two or more SPS configurations.

A method for wireless communications at a network entity is described. The method may include transmitting a first control message indicating one or more uplink SPS configurations and one or more downlink SPS configurations, transmitting a second control message activating two or more SPS configurations of the one or more uplink SPS configurations, or the one or more downlink SPS configurations, or both, where the two or more SPS configurations that are activated are associated with one or more CCs, and communicating with a UE based on the two or more SPS configurations that are activated.

An apparatus for wireless communications at a network entity is described. The apparatus may include a processor, memory coupled with the processor, and instructions stored in the memory. The instructions may be executable by the processor to cause the apparatus to transmit a first control message indicating one or more uplink SPS configurations and one or more downlink SPS configurations, transmit a second control message activating two or more SPS configurations of the one or more uplink SPS configurations, or the one or more downlink SPS configurations, or both, where the two or more SPS configurations that are activated are associated with one or more CCs, and communicate with a UE based on the two or more SPS configurations that are activated.

Another apparatus for wireless communications at a network entity is described. The apparatus may include means for transmitting a first control message indicating one or more uplink SPS configurations and one or more downlink SPS configurations, means for transmitting a second control message activating two or more SPS configurations of the one or more uplink SPS configurations, or the one or more downlink SPS configurations, or both, where the two or more SPS configurations that are activated are associated with one or more CCs, and means for communicating with a UE based on the two or more SPS configurations that are activated.

A non-transitory computer-readable medium storing code for wireless communications at a network entity is described. The code may include instructions executable by a processor to transmit a first control message indicating one or more uplink SPS configurations and one or more downlink SPS configurations, transmit a second control message activating two or more SPS configurations of the one or more uplink SPS configurations, or the one or more downlink SPS configurations, or both, where the two or more SPS configurations that are activated are associated with one or more CCs, and communicate with a UE based on the two or more SPS configurations that are activated.

Some examples of the method, apparatuses, and non-transitory computer-readable medium described herein may further include operations, features, means, or instructions for transmitting a third control message deactivating the two or more SPS configurations of the one or more uplink SPS configurations, or the one or more downlink SPS configurations, or both.

Some examples of the method, apparatuses, and non-transitory computer-readable medium described herein may further include operations, features, means, or instructions for skipping one or more respective transmission occasions associated with the two or more SPS configurations, where the one or more respective transmission occasions may be skipped based on a skipping indication included in the first control message.

Some examples of the method, apparatuses, and non-transitory computer-readable medium described herein may further include operations, features, means, or instructions for adding one or more respective transmission occasions associated with the two or more SPS configurations, where the one or more respective transmission occasions may be added based on an indication included in the first control message, and where the one or more respective transmission occasions may be used for communicating with the UE.

Some examples of the method, apparatuses, and non-transitory computer-readable medium described herein may further include operations, features, means, or instructions for shifting one or more respective time resources, one or more respective frequency resources, or both, associated with the two or more SPS configurations, where the one or more respective time resources, the one or more respective frequency resources, or both may be shifted based on an indication included in the first control message, and where the one or more respective time resources, the one or more respective frequency resources, or both, that may be shifted may be used for communicating with the UE.

Some examples of the method, apparatuses, and non-transitory computer-readable medium described herein may further include operations, features, means, or instructions for changing one or more respective beams associated with the two or more SPS configurations, where the one or more respective beams may be change based on an indication included in the first control message, and where the one or more respective beams may be used for communicating with the UE.

Some examples of the method, apparatuses, and non-transitory computer-readable medium described herein may further include operations, features, means, or instructions for receiving a request message indicating a request for the two or more SPS configurations, where transmitting the first control message, transmitting the second control message, or both, may be based on the request message.

In some examples of the method, apparatuses, and non-transitory computer-readable medium described herein, a first SPS configuration and a second SPS configuration of the two or more SPS configurations may be associated with a same CC, the first control message indicating a first set of parameters for the first SPS configuration and a second set of parameters for the second SPS configuration.

In some examples of the method, apparatuses, and non-transitory computer-readable medium described herein, a first SPS configuration of the two or more SPS configurations may be associated with a first CC and a second SPS configuration of the two or more SPS configurations may be associated with a second CC different from the first CC, the first control message indicating a first set of parameters for the first SPS configuration and a second set of parameters for the second SPS configuration.

In some examples of the method, apparatuses, and non-transitory computer-readable medium described herein, communicating with the UE may include operations, features, means, or instructions for communicating a same data stream via a set of multiple CCs using the two or more SPS configurations.

In some examples of the method, apparatuses, and non-transitory computer-readable medium described herein, communicating with the UE may include operations, features, means, or instructions for communicating two or more data streams via a set of multiple CCs using the two or more SPS configurations, where each data stream of the two or more data streams may be associated with at least one CC of the set of multiple CCs.

In some examples of the method, apparatuses, and non-transitory computer-readable medium described herein, transmitting the second control message may include operations, features, means, or instructions for transmitting the second control message via a first CC of the one or more CCs and transmitting the second control message via a second CC of the one or more CCs, the second CC being different from the first CC.

In some examples of the method, apparatuses, and non-transitory computer-readable medium described herein, the two or more SPS configurations may be activated based on a preconfigured time delay and the preconfigured time delay may be based on a capability of the UE, a quantity of the one or more CCs, frequencies associated with the one or more CCs, or any combination thereof.

In some examples of the method, apparatuses, and non-transitory computer-readable medium described herein, the first control message indicates a list of one or more CCs that may be associated with each SPS configuration of the two or more SPS configurations and CCs of each list of one or more components carriers may be used for communicating with the UE using the two or more SPS configurations.

### BRIEF DESCRIPTION OF THE DRAWINGS

FIG. 1 illustrates an example of a wireless communications system that supports joint semi-persistent scheduling (SPS) configuration in accordance with one or more aspects of the present disclosure.

FIG. 2 illustrates an example of a wireless communications system that supports joint SPS configuration in accordance with one or more aspects of the present disclosure.

FIG. 3 illustrates an example of an SPS configuration procedure that supports joint SPS configuration in accordance with one or more aspects of the present disclosure.

FIGS. 4 and 5 show block diagrams of devices that support joint SPS configuration in accordance with one or more aspects of the present disclosure.

FIG. 6 shows a block diagram of a communications manager that supports joint SPS configuration in accordance with one or more aspects of the present disclosure.

FIG. 7 shows a diagram of a system including a device that supports joint SPS configuration in accordance with one or more aspects of the present disclosure.

FIGS. 8 and 9 show block diagrams of devices that support joint SPS configuration in accordance with one or more aspects of the present disclosure.

FIG. 10 shows a block diagram of a communications manager that supports joint SPS configuration in accordance with one or more aspects of the present disclosure.

FIG. 11 shows a diagram of a system including a device that supports joint SPS configuration in accordance with one or more aspects of the present disclosure.

FIGS. 12 and 13 show flowcharts illustrating methods that support joint SPS configuration in accordance with one or more aspects of the present disclosure.

### DETAILED DESCRIPTION

In some wireless communications systems, a user equipment (UE) may transmit data to a network entity or receive data from the network entity using preconfigured time and frequency resources. For example, the UE may receive an indication of one or more resource configurations associated with semi-persistent scheduling (SPS), which may be referred to as an SPS configuration. That is, the UE may receive an indication of one or more uplink SPS configurations or one or more downlink SPS configurations, such that the UE may transmit data, receive data, or both via resources allocated to the UE in accordance with one or more active SPS configurations. In some cases, traffic associated with communications of the UE (e.g., extended reality (XR) traffic) may be transmitted in periodic bursts (e.g., may be bursty). As such, it may be desirable for a network entity to dynamically use multiple uplink and downlink SPS configurations to efficiently adapt to the traffic bursts. Uplink and downlink SPS configurations, however, may be separately configured and independently activated or deactivated, resulting in increased overhead.

Accordingly, techniques described herein may enable joint configuration, activation, deactivation, modification, or any combination thereof, of multiple SPS configurations to adapt to various types of traffic (e.g., bursty traffic) while reducing signaling overhead and enabling increased coordination between uplink and downlink SPS configurations. That is, a network entity may transmit control signaling to jointly handle two or more SPS configurations. For example, the network entity may configure, activate, deactivate, or modify two or more SPS configurations with a single control message. In some cases, a UE may request or recommend joint handling of SPS configurations. Additionally, or alternatively, the network entity may transmit control signaling to jointly handle two or more SPS configurations of a same component carrier (CC) or of multiple CCs.

Aspects of the disclosure are initially described in the context of wireless communications systems. Aspects of the disclosure are then described in the context of an SPS configuration procedure. Aspects of the disclosure are further illustrated by and described with reference to apparatus diagrams, system diagrams, and flowcharts that relate to joint SPS configuration.

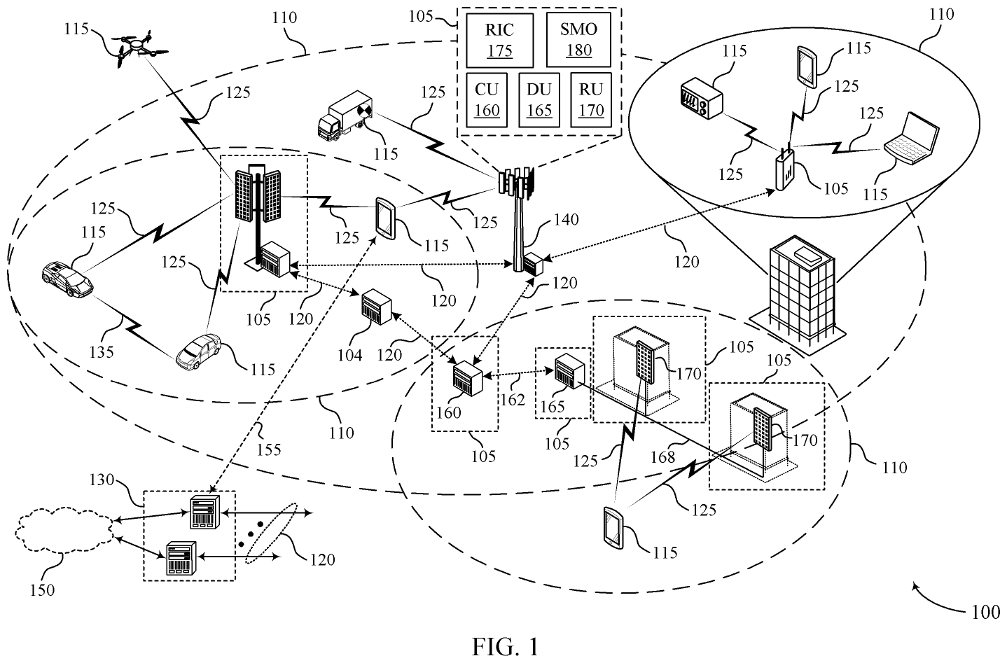

FIG. 1 illustrates an example of a wireless communications system 100 that supports joint SPS configuration in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support joint SPS configuration as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ˜N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support SPS-based resource allocation, which may include the configuration of time and frequency resources that may be used by a wireless device (e.g., a UE 115, a network entity 105) for transmission without receiving a resource grant. For example, downlink SPS may include the configuration of resources via RRC signaling (e.g., per serving cell and per bandwidth part). Activation of such resources for downlink transmissions may be triggered by an additional signal for a respective SPS configuration. Likewise, for uplink SPS (which may be referred to as configured grant or uplink configured grant), uplink resources may be configured and later active for uplink transmissions by a UE 115. SPS may enable transmission schemes with relatively reduced overhead, for example, enabling transmissions via a set of configured resources without requiring dynamic grants such resources.

The wireless communications system 100 may support joint SPS configuration such that a network entity 115 may activate two or more SPS configurations of a set of SPS configurations supported by a UE 115. For example, a UE 115 may receive a first control message indicating one or more uplink SPS configurations and one or more downlink SPS configurations. Additionally, the UE 115 may receive a second control message activating two or more SPS configurations of the one or more uplink SPS configurations, or the one or more downlink SPS configurations, or any combination thereof. In some cases, the two or more SPS configurations may be associated with one or more CCs. As an example, the two or more SPS configurations may be configured for operations across respective CCs, where, in some cases, a single downlink control information (DCI) may activate/deactivate different SPS configurations associated with two or more CCs (e.g., activate/deactivate a first downlink SPS configuration for a first CC, a second SPS configuration for a second CCs different from the first CC, and an uplink SPS configuration for a third CC that is different from the first and second CC). The UE 115 may communicate with a network entity 115 based on the two or more SPS configurations.

In some cases, the UE 115 may skip one or more respective transmission occasions associated with the two or more SPS configurations, add one or more respective transmission occasions associated with the two or more SPS configurations, shift one or more respective time resources, one or more respective frequency resources, or both, associated with the two or more SPS configurations, change one or more respective beams associated with the two or more SPS configurations, or any combination thereof, based on an additional indication in the first control message. Additionally, or alternatively, the UE 115 may receive a third control message deactivating two or more SPS configurations of the one or more uplink SPS configurations, one or more downlink SPS configurations, or both.

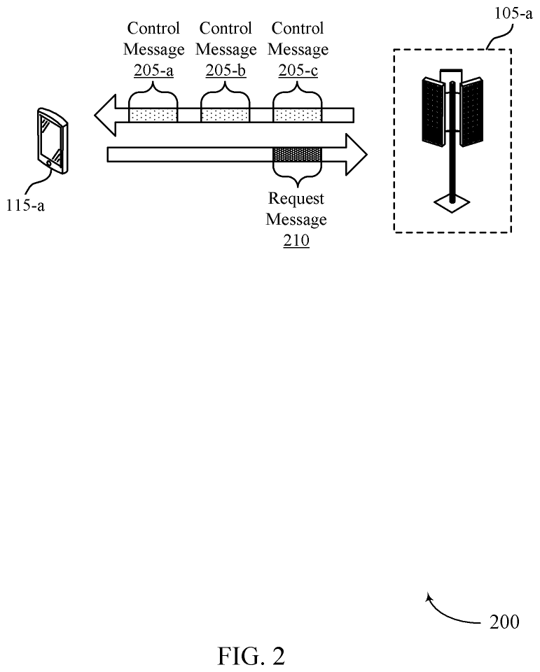

FIG. 2 illustrates an example of a wireless communications system 200 that supports joint SPS configuration in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a) and one or more UEs 115 (e.g., a UE 115-a), which may be examples of the corresponding devices described with reference to FIG. 1. In the example of FIG. 2, the network entity 105-a may be examples of a CU 160, a DU 165, an RU 170, a base station 140, an IAB node 104, or one or more other network nodes as described with reference to FIG. 1. In some cases, the UE 115-a may support joint SPS configuration.

In some wireless communications systems, such as the wireless communications system 200, a UE 115, such as the UE 115-a, may transmit data to a network entity 105, such as the network entity 105-a, receive data from the network entity 105-a, or both, using preconfigured time and frequency resources. For example, the UE may receive a control message 205 indicating one or more resource configurations associated with SPS scheduling, which may be referred to as an SPS configuration. That is, the UE 115-a may receive the control message 205 including an indication of one or more uplink SPS configurations (e.g., CG configurations) and one or more downlink SPS configurations, such that the UE 115-a may transmit data, receive data, or both, via resources allocated to the UE 115-a in accordance with one or more activated SPS configurations.

In some cases, traffic associated with communications of the UE (e.g., XR traffic) may be bursty. That is, the UE 115-a may periodically transmit data to the network entity 105-a, receive data from the network entity 105-a, or both, such that traffic bursts occur (e.g., with little or no activity between periodic times of increased activity associated with the traffic bursts). In some cases, the quantity (e.g., number) and size of packets per burst (e.g., traffic burst) may vary, bursts may be associated with non-integer periods (e.g., 16.67 ms period, 8.33 ms period, etc.), burst may arrive earlier or later than scheduled (e.g., jitter within +/−4 ms), different bursts may be associated with different configurations (e.g., multiple traffic flows may be configured with different configurations), packet delay budgets (PDBs) of each burst may result in varying latency, or any combination thereof. As such, one or more packets in each traffic burst may be delayed (.g., due to jitter) with respect to a scheduled time of arrival of the traffic burst, resulting in the one or more packets being considered invalid (e.g., and being thrown away). In such cases, the network entity 105-a may configure (e.g., activate, deactivate, or modify) one or more resource configurations, such as uplink SPS configurations or downlink SPS configurations, to adapt to the traffic bursts. However, the network entity 105-a may separately configure multiple SPS configurations, resulting in increased overhead (e.g., additional physical downlink control channel (PDCCH) signaling) and increase power consumption (e.g., due to PDCCH decoding).

Accordingly, the wireless communications system 200 may support joint SPS configuration. That is, uplink traffic patterns and downlink traffic patterns may be correlated (e.g., uplink pose may be related to downlink frame changes), such that one or more uplink SPS configurations, one or more downlink SPS configurations, or both, may be activated, deactivated, or modified (e.g., configured) according to a single control message 205 (e.g., jointly). For example, the UE 115-a may receive a control message 205-a indicating one or more uplink SPS configurations and one or more downlink SPS configurations (e.g., configuring the UE 115-a with the one or more uplink SPS configurations and one or more downlink SPS configurations). Additionally, the UE 115-a may receive a control message 205-b, activating two or more SPS configurations of the one or more uplink SPS configurations, the one or more downlink SPS configurations, or both. In some cases, the two or more SPS configurations may be associated with one CC or multiple CCs (e.g., cross-carrier configuration). For example, the control message 205-a may indicate a list of one or more CCs that are associated with each SPS configuration of the two or more SPS configurations, such that the UE 115-a communicates with the network entity 105-a using the two or more SPS configurations via CCs of each respective list of one or more CCs. Additionally (e.g., when the two or more SPS configurations are associated with multiple CCs), the UE 115-a may receive the control message 205-b via a first CC of the multiple CCs and receive the control message 205-b via a second CC of the multiple CCs, the second CC being different from the first CC.

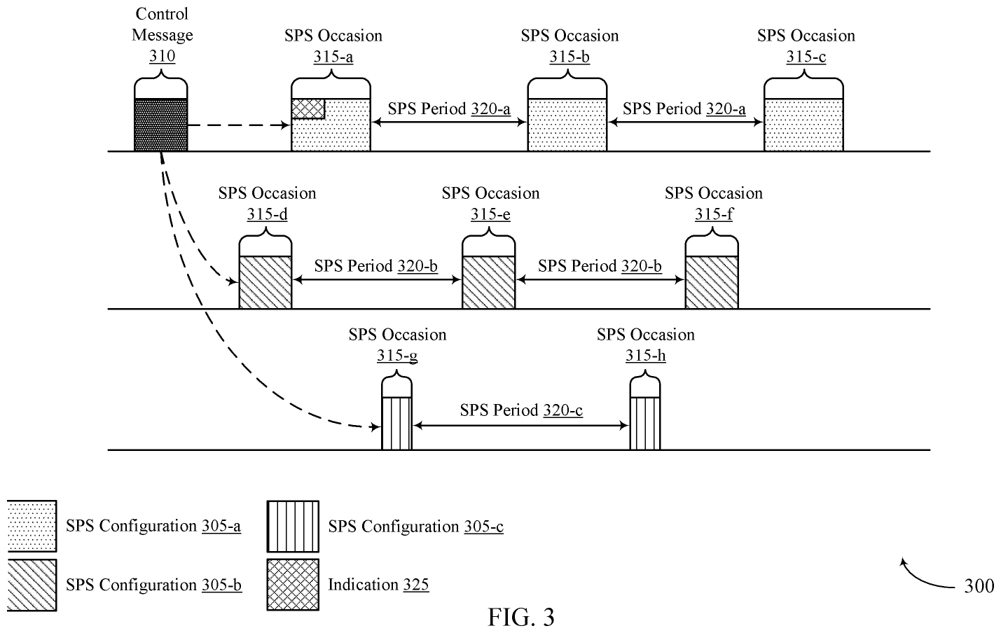

In some cases, the control message 205-a may include a skipping indication. The skipping indication may indicate one or more respective transmission occasions associated with the two or more SPS configurations for the UE 115-a to skip. That is, the UE 115-a may skip the one or more respective transmission occasions associated with the two or more SPS configurations based on receiving the skipping indication in the control message 205-a, as described with reference to FIG. 3.

In some cases, the control message 205-a may include an indication of one or more respective transmission occasions (e.g., SPS occasions) associated with the two or more SPS configurations for the UE 115-a to add. That is, the UE 115-a may add the one or more respective transmission occasions associated with the two or more SPS configurations based on the control message 205-a. The UE 115-a may use the one or more respective transmission occasions for communicating with the network entity 105-a. For example, the UE 115-a may communicate with the network entity 105-a according to a first SPS configuration and a second SPS configuration. Additionally, the UE 115-a may receive an indication of a first SPS occasion to add to the first SPS configuration and a second SPS occasion to add to the second SPS configuration. As such, the UE 115-a may communicate with the network entity 105-a during the first SPS occasion according to the first SPS configuration and during the second SPS occasion according to the second SPS configuration.

In some cases, the control message 205-a may include an indication of one or more respective time resources, one or more respective frequency resources, or both, associated with the two or more SPS configurations for the UE 115-a to shift. That is, the UE 115-a may shift the one or more respective time resources, the one or more respective frequency resources, or both, associated with the two or more SPS configurations based on the control message 205-a. The UE 115-a may use the one or more respective frequency resources, or both, associated with the two or more SPS configurations for communicating with the network entity 105-a. For example, the UE 115-a may communicate with the network entity 105-a according to a first SPS configuration associated with a first set of frequency resources and a second SPS configuration associated with a second set of frequency resources. Additionally, the UE 115-a may receive an indication of a third set of frequency resources associated with the first SPS configuration and a fourth set of frequency resources associated with the second SPS configuration. As such, the UE 115-a may communicate with the network entity 105-a according to the first SPS configuration via the third set of frequency resources and according to the second SPS configuration via the fourth set of frequency resources.

In some cases, the control message 205-a may include an indication of one or more respective beams associated with the two or more SPS configurations for the UE 115-a to change. That is, the UE 115-a may change the one or more respective beams associated with the two or more SPS configurations based on the control message 205-a. The UE 115-a may use the one or more respective beams associated with the two or more SPS configurations for communicating with the network entity 105-a. For example, the UE 115-a may communicate with the network entity 105-a according to a first SPS configuration via a first beam and a second SPS configuration via a second beam Additionally, the UE 115-a may receive an indication of a third beam associated with the first SPS configuration and a fourth beam associated with the second SPS configuration. As such, the UE 115-a may communicate with the network entity 105-a according to the first SPS configuration via the third beam and according to the second SPS configuration via the fourth beam.

In some cases, the UE 115-a may receive the control message 205-b and activate the two or more SPS configurations indicated in the control message 205-b based on a time delay (e.g., preconfigured time delay). In some examples, the control message 205-b may be an example of DCI, a MAC-CE, or the like. In some cases, the time delay may be based on a capability of the UE 115-a, a quantity of the one or more CCs associated with the two or more SPS configurations, frequencies associated with the one or more component carriers associated with the two or more SPS configurations, or any combination thereof. For example, the UE 115-a may receive the control message 205-b activating a first SPS configuration and a second SPS configuration, such that the UE 115-a may active the first SPS configuration and the second SPS configuration a duration (e.g., amount of time) after receiving the control message 205-b, where the duration is based on the time delay. In some cases, the UE 115-a may receive, from the network entity 105-a, an indication of the time delay.

In some cases, the UE 115-a may receive a control message 205-c deactivating the two or more SPS configurations of the one or more uplink SPS configurations, the one or more downlink SPS configurations, or both. For example, the UE 115-a may communicate with the network entity 105-a according to a first SPS configuration and a second SPS configuration. Additionally, the UE 115-a may receive the control message 205-c deactivating the first SPS configuration and the second SPS configuration. As such, the UE 115-a may deactivate the first SPS configuration and the second SPS configuration (e.g., refrain from communicating with the network entity 105-a according to the first SPS configuration and the second SPS configuration.

Additionally, or alternatively, the UE 115-a may transmit a request message 210 indicating a request for activation, deactivation, modification, or any combination thereof, of the two or more SPS configurations, such that the network entity 105-a may transmit the control message 205-a, the control message 205-b, or both, based on the request message 210. For example, the UE 115-a may communicate with the network entity 105-a according to a first uplink SPS configuration and a second downlink SPS configuration and may transmit the request message 210 indicating a request to activate a third downlink SPS configuration, such that the network entity 105-a may transmit the control message 205-b activating the third downlink SPS configuration. In another example, the UE 115-a may transmit the request message 210 indication a request to shift one or more respective frequency resources associated with the first uplink SPS configuration and the third downlink SPS configuration, such that the UE 115-a may transmit the control message 205-a indicating the shift of the one or more respective frequency resources associated with the first uplink SPS configuration and the third downlink SPS configuration.

FIG. 3 illustrates an example of an SPS configuration procedure 300 that supports joint SPS configuration in accordance with one or more aspects of the present disclosure. In some examples, the SPS configuration procedure 300 may implement or be implemented by aspects of the wireless communications system 100 and the wireless communications systems 200. For example, the SPS configuration procedure 300 may be performed by one or more network entities 105, by one or more UEs 115, or both, which may be examples of the corresponding devices described with reference to FIG. 1. In some cases, a UE 115 may receive a control message 310 activating two or more SPS configurations 305. The control message 310 may be an example of DCI, a MAC-CE, an RRC message, or the like.

A UE 115 may support multiple SPS configurations 305, including, but not limited to, an SPS configuration 305-a, an SPS configuration 305-b, and an SPS configuration 305-c. In some cases, the SPS configuration 305-a and the SPS configuration 305-c may be downlink SPS configurations 305 and the SPS configuration 305-b may be an uplink SPS configuration. Additionally, or alternatively, each SPS configuration 305 may be associated with a same or different CC. For example, the SPS configuration 305-a and the SPS configuration 305-b may be associated with a first CC and the SPS configuration 305-c may be associated with a second CC, where the first CC and the second CC are different.

Each SPS configuration 305 may configure the UE 115 with one or more SPS occasions 315. For example, the SPS configuration 305-a may configure the UE 115 with multiple SPS occasions 315, including an SPS occasion 315-a, an SPS occasion 315-b, and an SPS occasion 315-c, each separated by an SPS period 320-a. The SPS configuration 305-b may configure the UE 115 with multiple SPS occasions 315, including an SPS occasion 315-d, an SPS occasion 315-e, and an SPS occasion 315-f, each separated by an SPS period 320-b. The SPS configuration 305-c may configure the UE 115 with multiple SPS occasions 315, including an SPS occasion 315-g and an SPS occasion 315-h, each separated by an SPS period 320-c.

In some cases, the UE 115 may receive a control message 310 activating one or more SPS configurations 305. For example, the UE 115 may receive the control message 310 activating the SPS configuration 305-a, the SPS configuration 305-b, and the SPS configuration 305-c. In some cases, the UE 115 may receive the control message 310 via the first CC, via the second CC, or both. Additionally, the control message 310 may indicate a first set of parameters for the SPS configuration 305-a, a second set of parameters for the SPS configuration 305-b, and a third set of parameters for the SPS configuration 305-c. In some cases, the first set of parameters and the second set of parameters may be the same or different based on the SPS configuration 305-a and the SPS configuration 305-b being associated with the first CC (e.g., SPS configurations 305 on a given CC may be the same or different). Additionally, or alternatively, the first set of parameters, the second set of parameters, the third set of parameters, or any combination thereof, may be the same or different based on the SPS configuration 305-a and the SPS configuration 305-b being associated with the first CC and the SPS configuration 305-c being associated with the second CC (e.g., SPS configurations 305 across CCs may be the same or different).

In some cases, the UE 115 may receive an indication 325 in the control message 310, in one or more SPS occasions 315, or both, indicating for the UE 115 to skip one or more SPS occasions 315 associated with two or more SPS configurations 305. For example, the UE 115 may receive the indication 325 via the SPS occasion 315-a indicating for the UE 115 to skip the SPS occasion 315-b and the SPS occasion 315-e, such that the UE 115-a skips the SPS occasion 315-b and the SPS occasion 315-e based on the indication 325.

In some cases, the UE 115-a may communicate a same data stream via the first CC and the second CC. For example, the UE 115-a may communicate the same data stream via the first CC according to the SPS configuration 305-a and via the second CC according to the SPS configuration 305-c. Additionally, or alternatively, the UE 115-a may communicate two or more data streams via the first CC and the second CC. For example, the UE 115-a may communicate a first data stream via the first CC according to the SPS configuration 305-a and a second data stream via the second CC according to the SPS configuration 305-c. In another example, the UE 115-a may communicate the first data stream and the second data stream via the first CC according to the SPS configuration 305-a and the first data stream and the second data stream via the second CC according to the SPS configuration 305-c. In another example, the UE 115-a may communicate the first data stream and the second data stream via the first CC according to the SPS configuration 305-a and the first data stream via the second CC according to the SPS configuration 305-c.

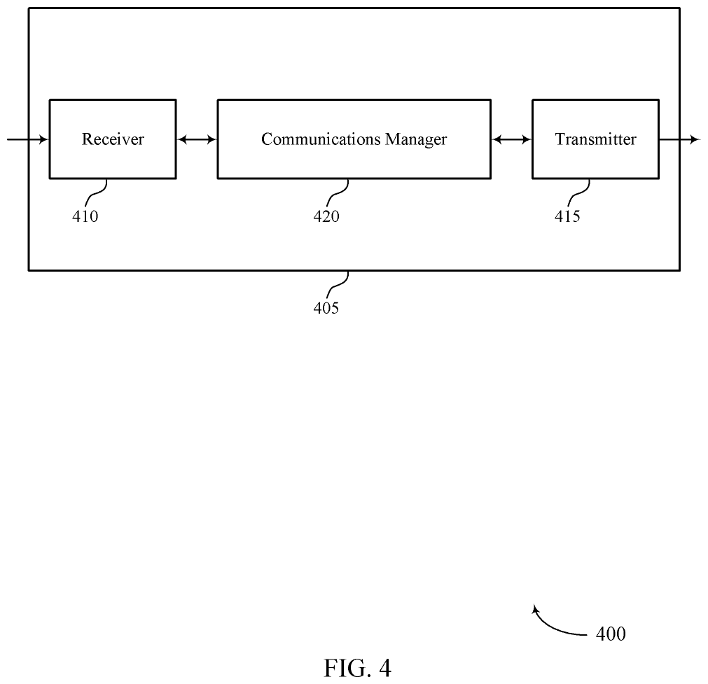

FIG. 4 shows a block diagram 400 of a device 405 that supports joint SPS configuration in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to joint SPS configuration). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to joint SPS configuration). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of joint SPS configuration as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for receiving a first control message indicating one or more uplink SPS configurations and one or more downlink SPS configurations. The communications manager 420 may be configured as or otherwise support a means for receiving a second control message activating two or more SPS configurations of the one or more uplink SPS configurations, or the one or more downlink SPS configurations, or both, where the two or more SPS configurations that are activated are associated with one or more CCs. The communications manager 420 may be configured as or otherwise support a means for communicating with a network entity based on the two or more SPS configurations that are activated.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for joint SPS configuration which may result in reduced processing, reduced power consumption, and more efficient utilization of communication resources, among other advantages.

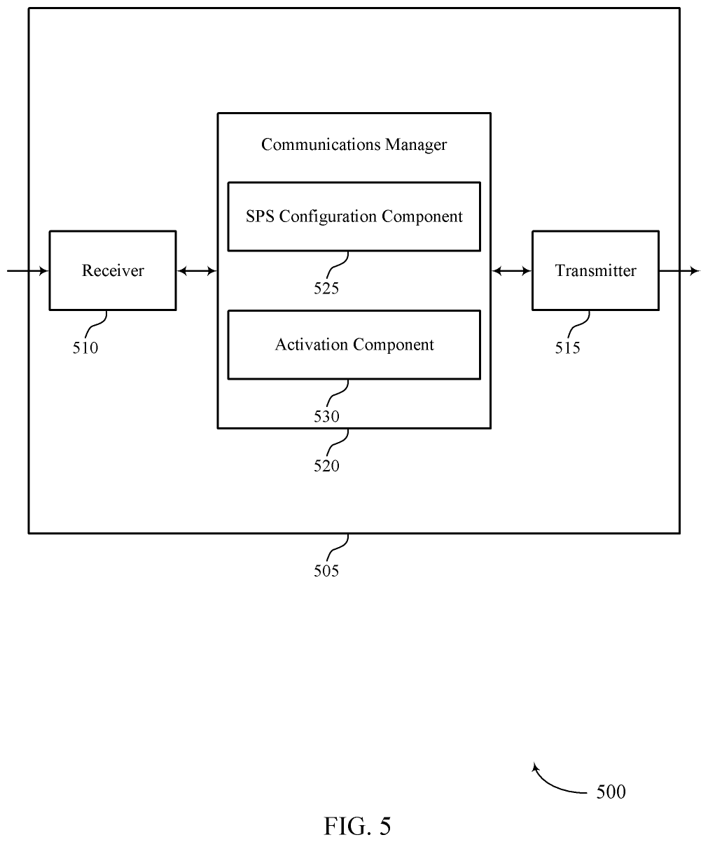

FIG. 5 shows a block diagram 500 of a device 505 that supports joint SPS configuration in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to joint SPS configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to joint SPS configuration). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of joint SPS configuration as described herein. For example, the communications manager 520 may include an SPS configuration component 525 an activation component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The SPS configuration component 525 may be configured as or otherwise support a means for receiving a first control message indicating one or more uplink SPS configurations and one or more downlink SPS configurations. The activation component 530 may be configured as or otherwise support a means for receiving a second control message activating two or more SPS configurations of the one or more uplink SPS configurations, or the one or more downlink SPS configurations, or both, where the two or more SPS configurations that are activated are associated with one or more CCs. The SPS configuration component 525 may be configured as or otherwise support a means for communicating with a network entity based on the two or more SPS configurations that are activated.

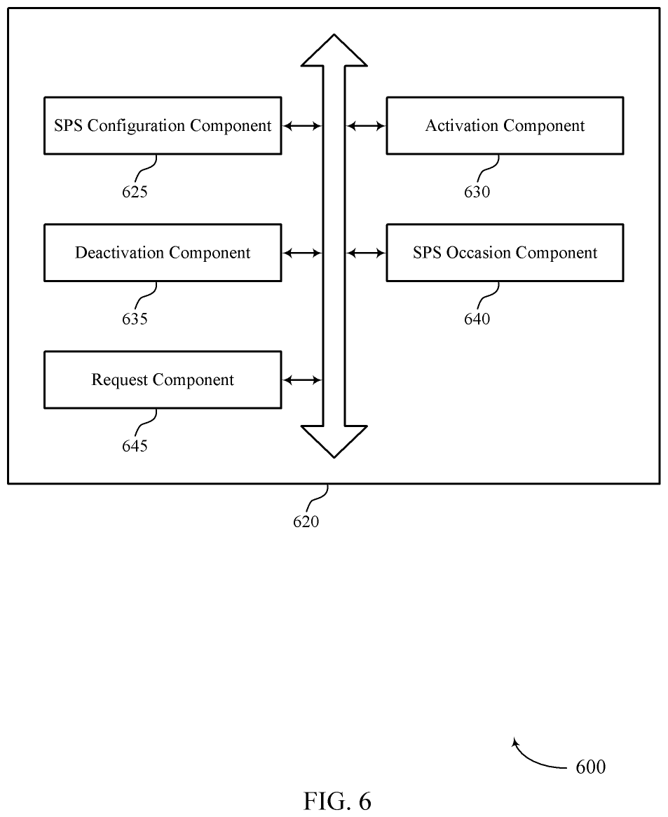

FIG. 6 shows a block diagram 600 of a communications manager 620 that supports joint SPS configuration in accordance with one or more aspects of the present disclosure. The communications manager 620 may be an example of aspects of a communications manager 420, a communications manager 520, or both, as described herein. The communications manager 620, or various components thereof, may be an example of means for performing various aspects of joint SPS configuration as described herein. For example, the communications manager 620 may include an SPS configuration component 625, an activation component 630, a deactivation component 635, an SPS occasion component 640, a request component 645, or any combination thereof. Each of these components may communicate, directly or indirectly, with one another (e.g., via one or more buses).

The communications manager 620 may support wireless communications at a UE in accordance with examples as disclosed herein. The SPS configuration component 625 may be configured as or otherwise support a means for receiving a first control message indicating one or more uplink SPS configurations and one or more downlink SPS configurations. The activation component 630 may be configured as or otherwise support a means for receiving a second control message activating two or more SPS configurations of the one or more uplink SPS configurations, or the one or more downlink SPS configurations, or both, where the two or more SPS configurations that are activated are associated with one or more CCs. In some examples, the SPS configuration component 625 may be configured as or otherwise support a means for communicating with a network entity based on the two or more SPS configurations that are activated.

In some examples, the deactivation component 635 may be configured as or otherwise support a means for receiving a third control message deactivating the two or more SPS configurations of the one or more uplink SPS configurations, or the one or more downlink SPS configurations, or both.

In some examples, the SPS occasion component 640 may be configured as or otherwise support a means for skipping one or more respective transmission occasions associated with the two or more SPS configurations, where the one or more respective transmission occasions are skipped based on a skipping indication included in the first control message.

In some examples, the SPS occasion component 640 may be configured as or otherwise support a means for adding one or more respective transmission occasions associated with the two or more SPS configurations, where the one or more respective transmission occasions are added based on an indication included in the first control message, and where the one or more respective transmission occasions are used for communicating with the network entity.

In some examples, the SPS configuration component 625 may be configured as or otherwise support a means for shifting one or more respective time resources, one or more respective frequency resources, or both, associated with the two or more SPS configurations, where the one or more respective time resources, the one or more respective frequency resources, or both are shifted based on an indication included in the first control message, and where the one or more respective time resources, the one or more respective frequency resources, or both, that are shifted are used for communicating with the network entity.

In some examples, the SPS configuration component 625 may be configured as or otherwise support a means for changing one or more respective beams associated with the two or more SPS configurations, where the one or more respective beams are changed based on an indication included in the first control message, and where the one or more respective beams are used for communicating with the network entity.

In some examples, the request component 645 may be configured as or otherwise support a means for transmitting a request message indicating a request for the two or more SPS configurations, where the first control message, the second control message, or both, is based on the request message.

In some examples, a first SPS configuration and a second SPS configuration of the two or more SPS configurations are associated with a same CC, the first control message indicating a first set of parameters for the first SPS configuration and a second set of parameters for the second SPS configuration.

In some examples, a first SPS configuration of the two or more SPS configurations is associated with a first CC and a second SPS configuration of the two or more SPS configurations is associated with a second CC different from the first CC, the first control message indicating a first set of parameters for the first SPS configuration and a second set of parameters for the second SPS configuration.

In some examples, to support communicating with the network entity, the SPS configuration component 625 may be configured as or otherwise support a means for communicating a same data stream via a set of multiple CCs using the two or more SPS configurations.

In some examples, to support communicating with the network entity, the SPS configuration component 625 may be configured as or otherwise support a means for communicating two or more data streams via a set of multiple CCs using the two or more SPS configurations, where each data stream of the two or more data streams is associated with at least one CC of the set of multiple CCs.

In some examples, to support receiving the second control message, the SPS configuration component 625 may be configured as or otherwise support a means for receiving the second control message via a first CC of the one or more CCs. In some examples, to support receiving the second control message, the SPS configuration component 625 may be configured as or otherwise support a means for receiving the second control message via a second CC of the one or more CCs, the second CC being different from the first CC.

In some examples, the two or more SPS configurations are activated based on a preconfigured time delay. In some examples, the preconfigured time delay is based on a capability of the UE, a quantity of the one or more CCs, frequencies associated with the one or more CCs, or any combination thereof.

In some examples, the first control message indicates a list of one or more CCs that is associated with each SPS configuration of the two or more SPS configurations. In some examples, CCs of each list of one or more components carriers are used for communicating with the network entity using the two or more SPS configurations.

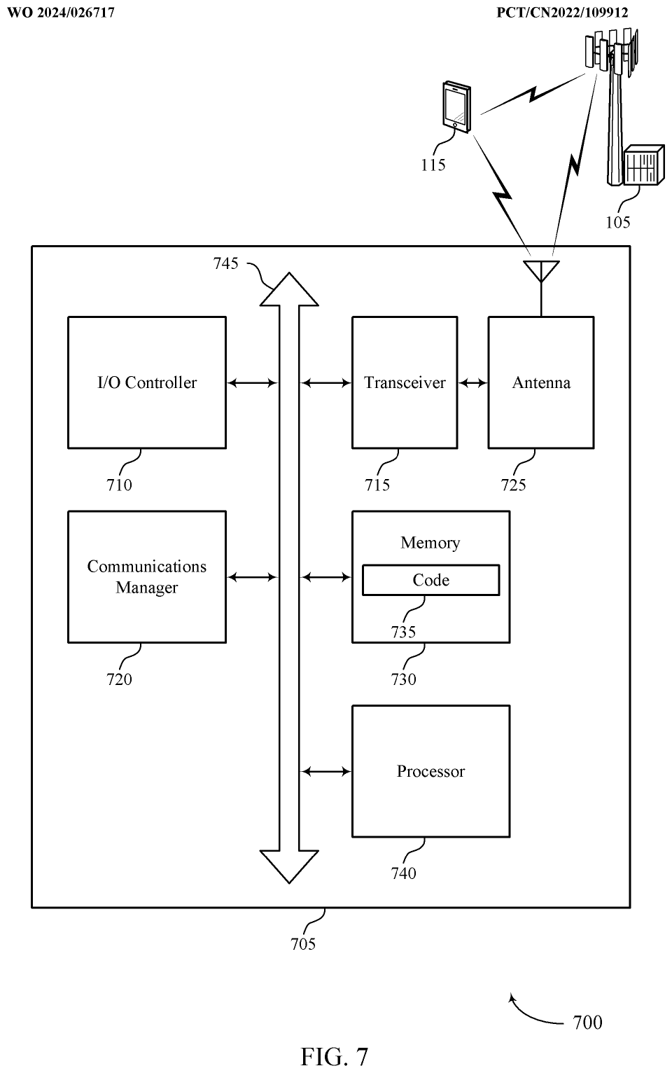

FIG. 7 shows a diagram of a system 700 including a device 705 that supports joint SPS configuration in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting joint SPS configuration). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving a first control message indicating one or more uplink SPS configurations and one or more downlink SPS configurations. The communications manager 720 may be configured as or otherwise support a means for receiving a second control message activating two or more SPS configurations of the one or more uplink SPS configurations, or the one or more downlink SPS configurations, or both, where the two or more SPS configurations that are activated are associated with one or more CCs. The communications manager 720 may be configured as or otherwise support a means for communicating with a network entity based on the two or more SPS configurations that are activated.

By including or configuring the communications manager 720 in accordance with examples as described herein, the device 705 may support techniques joint SPS configuration which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of joint SPS configuration as described herein, or the processor 740 and the memory 730 may be otherwise configured to perform or support such operations.

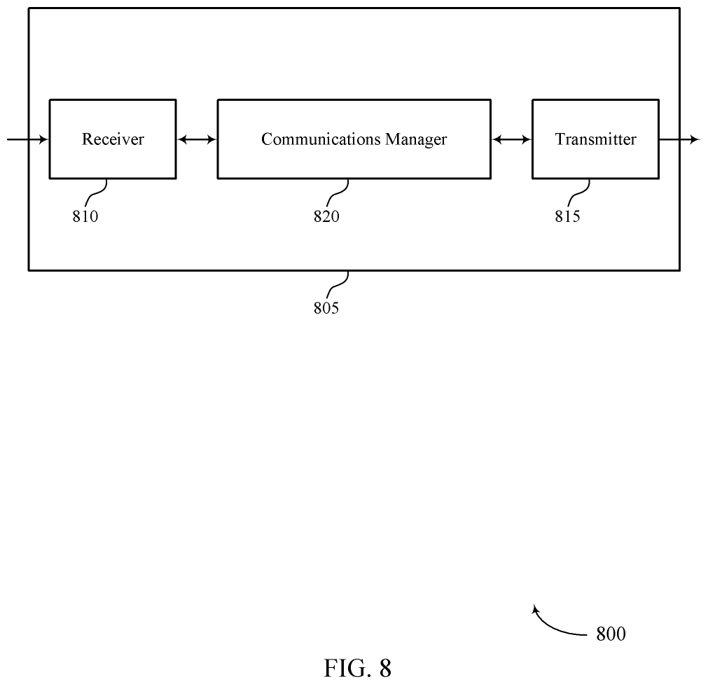

FIG. 8 shows a block diagram 800 of a device 805 that supports joint SPS configuration in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of joint SPS configuration as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 may be configured as or otherwise support a means for transmitting a first control message indicating one or more uplink SPS configurations and one or more downlink SPS configurations. The communications manager 820 may be configured as or otherwise support a means for transmitting a second control message activating two or more SPS configurations of the one or more uplink SPS configurations, or the one or more downlink SPS configurations, or both, where the two or more SPS configurations that are activated are associated with one or more CCs. The communications manager 820 may be configured as or otherwise support a means for communicating with a UE based on the two or more SPS configurations that are activated.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for joint SPS configuration which may result in reduced processing, reduced power consumption, and more efficient utilization of communication resources, among other advantages.

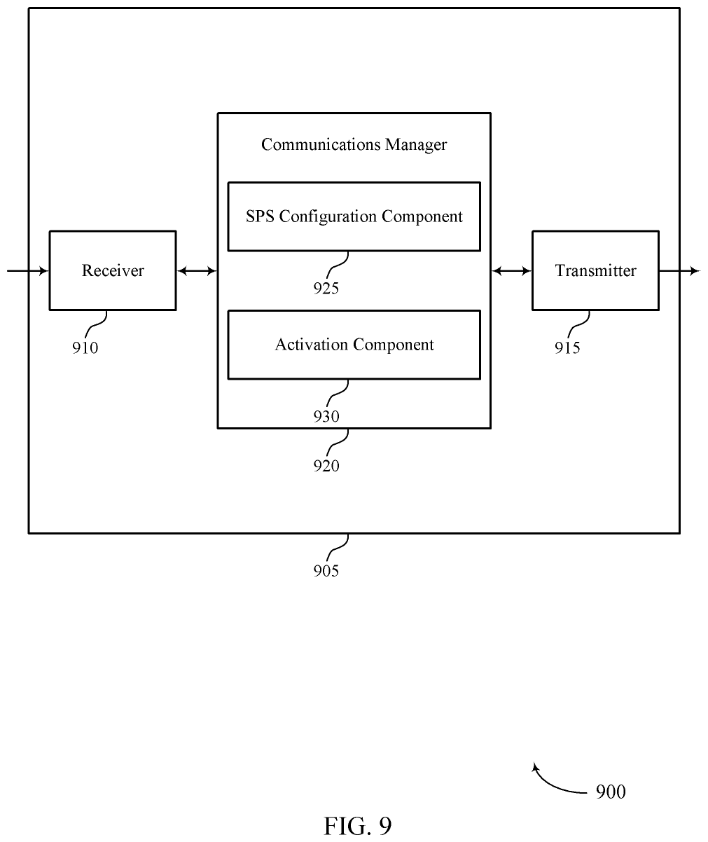

FIG. 9 shows a block diagram 900 of a device 905 that supports joint SPS configuration in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of joint SPS configuration as described herein. For example, the communications manager 920 may include an SPS configuration component 925 an activation component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The SPS configuration component 925 may be configured as or otherwise support a means for transmitting a first control message indicating one or more uplink SPS configurations and one or more downlink SPS configurations. The activation component 930 may be configured as or otherwise support a means for transmitting a second control message activating two or more SPS configurations of the one or more uplink SPS configurations, or the one or more downlink SPS configurations, or both, where the two or more SPS configurations that are activated are associated with one or more CCs. The SPS configuration component 925 may be configured as or otherwise support a means for communicating with a UE based on the two or more SPS configurations that are activated.

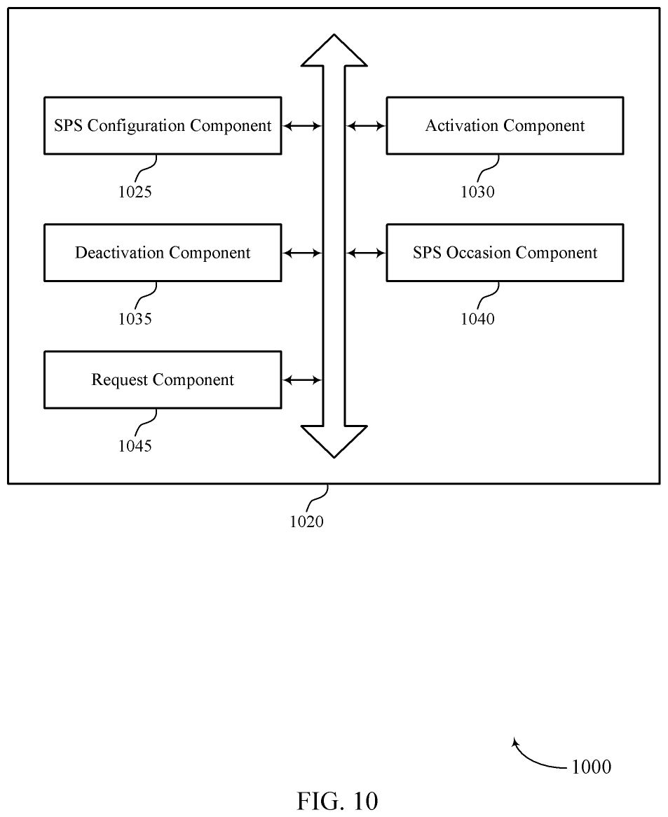

FIG. 10 shows a block diagram 1000 of a communications manager 1020 that supports joint SPS configuration in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of joint SPS configuration as described herein. For example, the communications manager 1020 may include an SPS configuration component 1025, an activation component 1030, a deactivation component 1035, an SPS occasion component 1040, a request component 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The SPS configuration component 1025 may be configured as or otherwise support a means for transmitting a first control message indicating one or more uplink SPS configurations and one or more downlink SPS configurations. The activation component 1030 may be configured as or otherwise support a means for transmitting a second control message activating two or more SPS configurations of the one or more uplink SPS configurations, or the one or more downlink SPS configurations, or both, where the two or more SPS configurations that are activated are associated with one or more CCs. In some examples, the SPS configuration component 1025 may be configured as or otherwise support a means for communicating with a UE based on the two or more SPS configurations that are activated.

In some examples, the deactivation component 1035 may be configured as or otherwise support a means for transmitting a third control message deactivating the two or more SPS configurations of the one or more uplink SPS configurations, or the one or more downlink SPS configurations, or both.

In some examples, the SPS occasion component 1040 may be configured as or otherwise support a means for skipping one or more respective transmission occasions associated with the two or more SPS configurations, where the one or more respective transmission occasions are skipped based on a skipping indication included in the first control message.

In some examples, the SPS occasion component 1040 may be configured as or otherwise support a means for adding one or more respective transmission occasions associated with the two or more SPS configurations, where the one or more respective transmission occasions are added based on an indication included in the first control message, and where the one or more respective transmission occasions are used for communicating with the UE.

In some examples, the SPS configuration component 1025 may be configured as or otherwise support a means for shifting one or more respective time resources, one or more respective frequency resources, or both, associated with the two or more SPS configurations, where the one or more respective time resources, the one or more respective frequency resources, or both are shifted based on an indication included in the first control message, and where the one or more respective time resources, the one or more respective frequency resources, or both, that are shifted are used for communicating with the UE.

In some examples, the SPS configuration component 1025 may be configured as or otherwise support a means for changing one or more respective beams associated with the two or more SPS configurations, where the one or more respective beams are change based on an indication included in the first control message, and where the one or more respective beams are used for communicating with the UE.

In some examples, the request component 1045 may be configured as or otherwise support a means for receiving a request message indicating a request for the two or more SPS configurations, where transmitting the first control message, transmitting the second control message, or both, is based on the request message.

In some examples, a first SPS configuration and a second SPS configuration of the two or more SPS configurations are associated with a same CC, the first control message indicating a first set of parameters for the first SPS configuration and a second set of parameters for the second SPS configuration.

In some examples, a first SPS configuration of the two or more SPS configurations is associated with a first CC and a second SPS configuration of the two or more SPS configurations is associated with a second CC different from the first CC, the first control message indicating a first set of parameters for the first SPS configuration and a second set of parameters for the second SPS configuration.

In some examples, to support communicating with the UE, the SPS configuration component 1025 may be configured as or otherwise support a means for communicating a same data stream via a set of multiple CCs using the two or more SPS configurations.

In some examples, to support communicating with the UE, the SPS configuration component 1025 may be configured as or otherwise support a means for communicating two or more data streams via a set of multiple CCs using the two or more SPS configurations, where each data stream of the two or more data streams is associated with at least one CC of the set of multiple CCs.

In some examples, to support transmitting the second control message, the SPS configuration component 1025 may be configured as or otherwise support a means for transmitting the second control message via a first CC of the one or more CCs. In some examples, to support transmitting the second control message, the SPS configuration component 1025 may be configured as or otherwise support a means for transmitting the second control message via a second CC of the one or more CCs, the second CC being different from the first CC.

In some examples, the two or more SPS configurations are activated based on a preconfigured time delay. In some examples, the preconfigured time delay is based on a capability of the UE, a quantity of the one or more CCs, frequencies associated with the one or more CCs, or any combination thereof.

In some examples, the first control message indicates a list of one or more CCs that is associated with each SPS configuration of the two or more SPS configurations. In some examples, CCs of each list of one or more components carriers are used for communicating with the UE using the two or more SPS configurations.

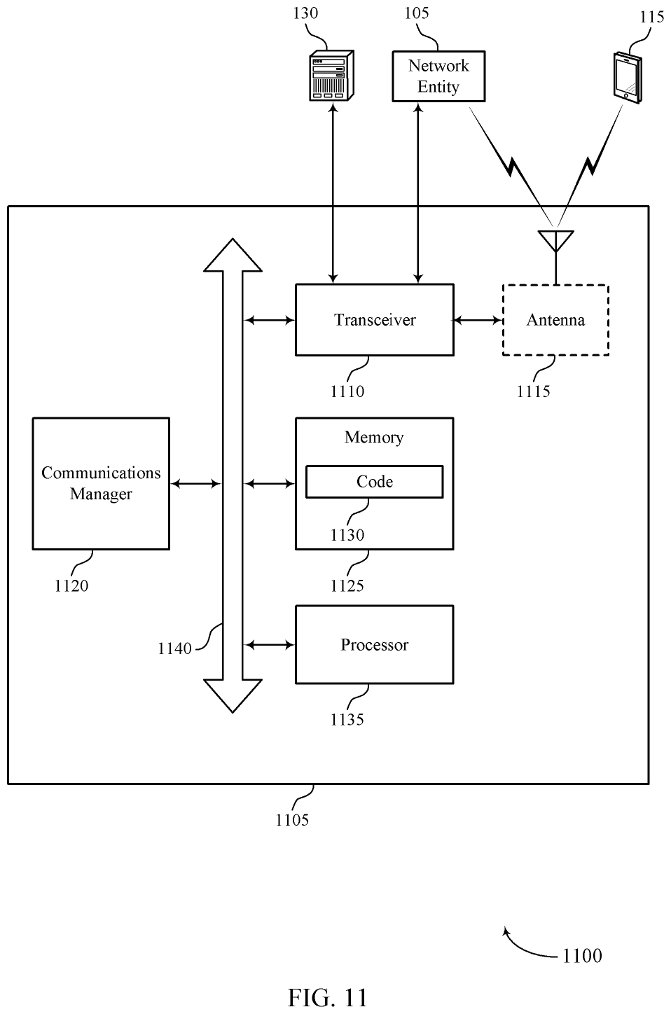

FIG. 11 shows a diagram of a system 1100 including a device 1105 that supports joint SPS configuration in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting joint SPS configuration). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 may be configured as or otherwise support a means for transmitting a first control message indicating one or more uplink SPS configurations and one or more downlink SPS configurations. The communications manager 1120 may be configured as or otherwise support a means for transmitting a second control message activating two or more SPS configurations of the one or more uplink SPS configurations, or the one or more downlink SPS configurations, or both, where the two or more SPS configurations that are activated are associated with one or more CCs. The communications manager 1120 may be configured as or otherwise support a means for communicating with a UE based on the two or more SPS configurations that are activated.

By including or configuring the communications manager 1120 in accordance with examples as described herein, the device 1105 may support techniques for joint SPS configuration which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of joint SPS configuration as described herein, or the processor 1135 and the memory 1125 may be otherwise configured to perform or support such operations.

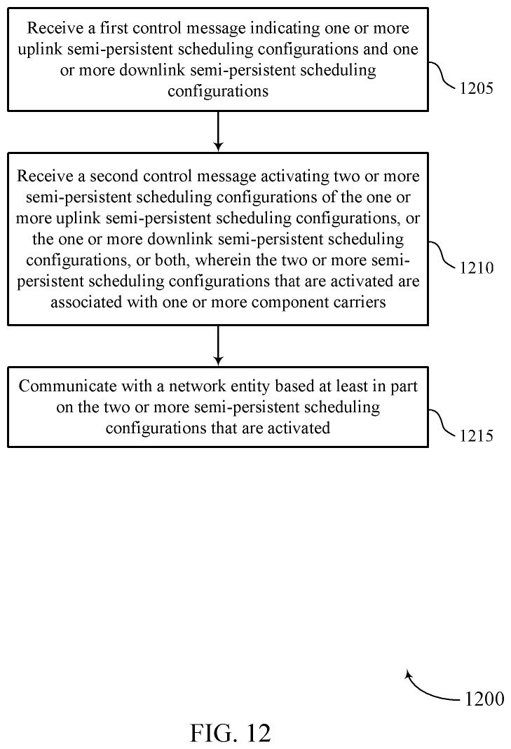

FIG. 12 shows a flowchart illustrating a method 1200 that supports joint SPS configuration in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first control message indicating one or more uplink SPS configurations and one or more downlink SPS configurations. The operations of 1205 may be performed in accordance with examples as disclosed herein. In some examples, aspects of the operations of 1205 may be performed by an SPS configuration component 625 as described with reference to FIG. 6.

At 1210, the method may include receiving a second control message activating two or more SPS configurations of the one or more uplink SPS configurations, or the one or more downlink SPS configurations, or both, where the two or more SPS configurations that are activated are associated with one or more CCs. The operations of 1210 may be performed in accordance with examples as disclosed herein. In some examples, aspects of the operations of 1210 may be performed by an activation component 630 as described with reference to FIG. 6.

At 1215, the method may include communicating with a network entity based on the two or more SPS configurations that are activated. The operations of 1215 may be performed in accordance with examples as disclosed herein. In some examples, aspects of the operations of 1215 may be performed by an SPS configuration component 625 as described with reference to FIG. 6.

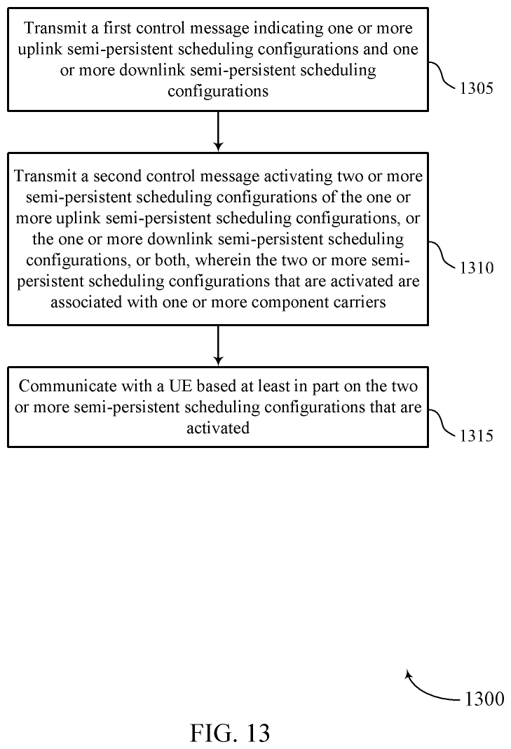

FIG. 13 shows a flowchart illustrating a method 1300 that supports joint SPS configuration in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include transmitting a first control message indicating one or more uplink SPS configurations and one or more downlink SPS configurations. The operations of 1305 may be performed in accordance with examples as disclosed herein. In some examples, aspects of the operations of 1305 may be performed by an SPS configuration component 1025 as described with reference to FIG. 10.

At 1310, the method may include transmitting a second control message activating two or more SPS configurations of the one or more uplink SPS configurations, or the one or more downlink SPS configurations, or both, where the two or more SPS configurations that are activated are associated with one or more CCs. The operations of 1310 may be performed in accordance with examples as disclosed herein. In some examples, aspects of the operations of 1310 may be performed by an activation component 1030 as described with reference to FIG. 10.

At 1315, the method may include communicating with a UE based on the two or more SPS configurations that are activated. The operations of 1315 may be performed in accordance with examples as disclosed herein. In some examples, aspects of the operations of 1315 may be performed by an SPS configuration component 1025 as described with reference to FIG. 10.

The following provides an overview of aspects of the present disclosure:
Aspect 1: A method for wireless communications at a UE, comprising: receiving a first control message indicating one or more uplink SPS configurations and one or more downlink SPS configurations; receiving a second control message activating two or more SPS configurations of the one or more uplink SPS configurations, or the one or more downlink SPS configurations, or both, wherein the two or more SPS configurations that are activated are associated with one or more CCs; and communicating with a network entity based at least in part on the two or more SPS configurations that are activated.
Aspect 2: The method of aspect 1, further comprising: receiving a third control message deactivating the two or more SPS configurations of the one or more uplink SPS configurations, or the one or more downlink SPS configurations, or both.
Aspect 3: The method of any of aspects 1 through 2, further comprising: skipping one or more respective transmission occasions associated with the two or more SPS configurations, wherein the one or more respective transmission occasions are skipped based at least in part on a skipping indication included in the first control message.
Aspect 4: The method of any of aspects 1 through 3, further comprising: adding one or more respective transmission occasions associated with the two or more SPS configurations, wherein the one or more respective transmission occasions are added based at least in part on an indication included in the first control message, and wherein the one or more respective transmission occasions are used for communicating with the network entity.
Aspect 5: The method of any of aspects 1 through 4, further comprising: shifting one or more respective time resources, one or more respective frequency resources, or both, associated with the two or more SPS configurations, wherein the one or more respective time resources, the one or more respective frequency resources, or both are shifted based at least in part on an indication included in the first control message, and wherein the one or more respective time resources, the one or more respective frequency resources, or both, that are shifted are used for communicating with the network entity.
Aspect 6: The method of any of aspects 1 through 5, further comprising: changing one or more respective beams associated with the two or more SPS configurations, wherein the one or more respective beams are changed based at least in part on an indication included in the first control message, and wherein the one or more respective beams are used for communicating with the network entity.
Aspect 7: The method of any of aspects 1 through 6, further comprising: transmitting a request message indicating a request for the two or more SPS configurations, wherein the first control message, the second control message, or both, is based at least in part on the request message.
Aspect 8: The method of any of aspects 1 through 7, wherein a first SPS configuration and a second SPS configuration of the two or more SPS configurations are associated with a same CC, the first control message indicating a first set of parameters for the first SPS configuration and a second set of parameters for the second SPS configuration.
Aspect 9: The method of any of aspects 1 through 8, wherein a first SPS configuration of the two or more SPS configurations is associated with a first CC and a second SPS configuration of the two or more SPS configurations is associated with a second CC different from the first CC, the first control message indicating a first set of parameters for the first SPS configuration and a second set of parameters for the second SPS configuration.
Aspect 10: The method of any of aspects 1 through 9, wherein communicating with the network entity comprises: communicating a same data stream via a plurality of CCs using the two or more SPS configurations.
Aspect 11: The method of any of aspects 1 through 10, wherein communicating with the network entity comprises: communicating two or more data streams via a plurality of CCs using the two or more SPS configurations, wherein each data stream of the two or more data streams is associated with at least one CC of the plurality of CCs.
Aspect 12: The method of any of aspects 1 through 11, wherein receiving the second control message comprises: receiving the second control message via a first CC of the one or more CCs; and receiving the second control message via a second CC of the one or more CCs, the second CC being different from the first CC.
Aspect 13: The method of any of aspects 1 through 12, wherein the two or more SPS configurations are activated based at least in part on a preconfigured time delay, the preconfigured time delay is based at least in part on a capability of the UE, a quantity of the one or more CCs, frequencies associated with the one or more CCs, or any combination thereof.
Aspect 14: The method of any of aspects 1 through 13, wherein the first control message indicates a list of one or more CCs that is associated with each SPS configuration of the two or more SPS configurations, and CCs of each list of one or more components carriers are used for communicating with the network entity using the two or more SPS configurations.
Aspect 15: A method for wireless communications at a network entity, comprising: transmitting a first control message indicating one or more uplink SPS configurations and one or more downlink SPS configurations; transmitting a second control message activating two or more SPS configurations of the one or more uplink SPS configurations, or the one or more downlink SPS configurations, or both, wherein the two or more SPS configurations that are activated are associated with one or more CCs; and communicating with a UE based at least in part on the two or more SPS configurations that are activated.
Aspect 16: The method of aspect 15, further comprising: transmitting a third control message deactivating the two or more SPS configurations of the one or more uplink SPS configurations, or the one or more downlink SPS configurations, or both.
Aspect 17: The method of any of aspects 15 through 16, further comprising: skipping one or more respective transmission occasions associated with the two or more SPS configurations, wherein the one or more respective transmission occasions are skipped based at least in part on a skipping indication included in the first control message.
Aspect 18: The method of any of aspects 15 through 17, further comprising: adding one or more respective transmission occasions associated with the two or more SPS configurations, wherein the one or more respective transmission occasions are added based at least in part on an indication included in the first control message, and wherein the one or more respective transmission occasions are used for communicating with the UE.
Aspect 19: The method of any of aspects 15 through 18, further comprising: shifting one or more respective time resources, one or more respective frequency resources, or both, associated with the two or more SPS configurations, wherein the one or more respective time resources, the one or more respective frequency resources, or both are shifted based at least in part on an indication included in the first control message, and wherein the one or more respective time resources, the one or more respective frequency resources, or both, that are shifted are used for communicating with the UE.
Aspect 20: The method of any of aspects 15 through 19, further comprising: changing one or more respective beams associated with the two or more SPS configurations, wherein the one or more respective beams are change based at least in part on an indication included in the first control message, and wherein the one or more respective beams are used for communicating with the UE.
Aspect 21: The method of any of aspects 15 through 20, further comprising: receiving a request message indicating a request for the two or more SPS configurations, wherein transmitting the first control message, transmitting the second control message, or both, is based at least in part on the request message.
Aspect 22: The method of any of aspects 15 through 21, wherein a first SPS configuration and a second SPS configuration of the two or more SPS configurations are associated with a same CC, the first control message indicating a first set of parameters for the first SPS configuration and a second set of parameters for the second SPS configuration.
Aspect 23: The method of any of aspects 15 through 22, wherein a first SPS configuration of the two or more SPS configurations is associated with a first CC and a second SPS configuration of the two or more SPS configurations is associated with a second CC different from the first CC, the first control message indicating a first set of parameters for the first SPS configuration and a second set of parameters for the second SPS configuration.
Aspect 24: The method of any of aspects 15 through 23, wherein communicating with the UE comprises: communicating a same data stream via a plurality of CCs using the two or more SPS configurations.
Aspect 25: The method of any of aspects 15 through 24, wherein communicating with the UE comprises: communicating two or more data streams via a plurality of CCs using the two or more SPS configurations, wherein each data stream of the two or more data streams is associated with at least one CC of the plurality of CCs.
Aspect 26: The method of any of aspects 15 through 25, wherein transmitting the second control message comprises: transmitting the second control message via a first CC of the one or more CCs; and transmitting the second control message via a second CC of the one or more CCs, the second CC being different from the first CC.
Aspect 27: The method of any of aspects 15 through 26, wherein the two or more SPS configurations are activated based at least in part on a preconfigured time delay, the preconfigured time delay is based at least in part on a capability of the UE, a quantity of the one or more CCs, frequencies associated with the one or more CCs, or any combination thereof.
Aspect 28: The method of any of aspects 15 through 27, wherein the first control message indicates a list of one or more CCs that is associated with each SPS configuration of the two or more SPS configurations, and CCs of each list of one or more components carriers are used for communicating with the UE using the two or more SPS configurations.
Aspect 29: An apparatus for wireless communications at a UE, comprising a processor; memory coupled with the processor; and instructions stored in the memory and executable by the processor to cause the apparatus to perform a method of any of aspects 1 through 14.
Aspect 30: An apparatus for wireless communications at a UE, comprising at least one means for performing a method of any of aspects 1 through 14.

Aspect 31: A non-transitory computer-readable medium storing code for wireless communications at a UE, the code comprising instructions executable by a processor to perform a method of any of aspects 1 through 14.
Aspect 32: An apparatus for wireless communications at a network entity, comprising a processor; memory coupled with the processor; and instructions stored in the memory and executable by the processor to cause the apparatus to perform a method of any of aspects 15 through 28.
Aspect 33: An apparatus for wireless communications at a network entity, comprising at least one means for performing a method of any of aspects 15 through 28.
Aspect 34: A non-transitory computer-readable medium storing code for wireless communications at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first control message indicating one or more uplink semi-persistent scheduling configurations and one or more downlink semi-persistent scheduling configurations;
receiving a second control message activating two or more semi-persistent scheduling configurations of the one or more uplink semi-persistent scheduling configurations, or the one or more downlink semi-persistent scheduling configurations, or both, wherein the two or more semi-persistent scheduling configurations that are activated are associated with one or more component carriers; and
communicating with a network entity based at least in part on the two or more semi-persistent scheduling configurations that are activated.

2. The method of claim 1, further comprising:
receiving a third control message deactivating the two or more semi-persistent scheduling configurations of the one or more uplink semi-persistent scheduling configurations, or the one or more downlink semi-persistent scheduling configurations, or both.

3. The method of claim 1, further comprising:
skipping one or more respective transmission occasions associated with the two or more semi-persistent scheduling configurations, wherein the one or more respective transmission occasions are skipped based at least in part on a skipping indication included in the first control message.

4. The method of claim 1, further comprising:
adding one or more respective transmission occasions associated with the two or more semi-persistent scheduling configurations, wherein the one or more respective transmission occasions are added based at least in part on an indication included in the first control message, and wherein the one or more respective transmission occasions are used for communicating with the network entity.

5. The method of claim 1, further comprising:
shifting one or more respective time resources, one or more respective frequency resources, or both, associated with the two or more semi-persistent scheduling configurations, wherein the one or more respective time resources, the one or more respective frequency resources, or both are shifted based at least in part on an indication included in the first control message, and wherein the one or more respective time resources, the one or more respective frequency resources, or both, that are shifted are used for communicating with the network entity.

6. The method of claim 1, further comprising:
changing one or more respective beams associated with the two or more semi-persistent scheduling configurations, wherein the one or more respective beams are changed based at least in part on an indication included in the first control message, and wherein the one or more respective beams are used for communicating with the network entity.

7. The method of claim 1, further comprising:
transmitting a request message indicating a request for the two or more semi-persistent scheduling configurations, wherein the first control message, the second control message, or both, is based at least in part on the request message.

8. The method of claim 1, wherein a first semi-persistent scheduling configuration and a second semi-persistent scheduling configuration of the two or more semi-persistent scheduling configurations are associated with a same component carrier, the first control message indicating a first set of parameters for the first semi-persistent scheduling configuration and a second set of parameters for the second semi-persistent scheduling configuration.

9. The method of claim 1, wherein a first semi-persistent scheduling configuration of the two or more semi-persistent scheduling configurations is associated with a first component carrier and a second semi-persistent scheduling configuration of the two or more semi-persistent scheduling configurations is associated with a second component carrier different from the first component carrier, the first control message indicating a first set of parameters for the first semi-persistent scheduling configuration and a second set of parameters for the second semi-persistent scheduling configuration.

10. The method of claim 1, wherein communicating with the network entity comprises:
communicating a same data stream via a plurality of component carriers using the two or more semi-persistent scheduling configurations.

11. The method of claim 1, wherein communicating with the network entity comprises:
communicating two or more data streams via a plurality of component carriers using the two or more semi-persistent scheduling configurations, wherein each data stream of the two or more data streams is associated with at least one component carrier of the plurality of component carriers.

12. The method of claim 1, wherein receiving the second control message comprises:
receiving the second control message via a first component carrier of the one or more component carriers; and
receiving the second control message via a second component carrier of the one or more component carriers, the second component carrier being different from the first component carrier.

13. The method of claim 1, wherein the two or more semi-persistent scheduling configurations are activated based at least in part on a preconfigured time delay, wherein the preconfigured time delay is based at least in part on a capability of the UE, a quantity of the one or more component carriers, frequencies associated with the one or more component carriers, or any combination thereof.

14. The method of claim 1, wherein the first control message indicates a list of one or more component carriers that is associated with each semi-persistent scheduling configuration of the two or more semi-persistent scheduling configurations, and wherein component carriers of each list of one or more components carriers are used for communicating with the network entity using the two or more semi-persistent scheduling configurations.

15. A method for wireless communications at a network entity, comprising:
transmitting a first control message indicating one or more uplink semi-persistent scheduling configurations and one or more downlink semi-persistent scheduling configurations;
transmitting a second control message activating two or more semi-persistent scheduling configurations of the one or more uplink semi-persistent scheduling configurations, or the one or more downlink semi-persistent scheduling configurations, or both, wherein the two or more semi-persistent scheduling configurations that are activated are associated with one or more component carriers; and
communicating with a user equipment (UE) based at least in part on the two or more semi-persistent scheduling configurations that are activated.

16. The method of claim 15, further comprising:
transmitting a third control message deactivating the two or more semi-persistent scheduling configurations of the one or more uplink semi-persistent scheduling configurations, or the one or more downlink semi-persistent scheduling configurations, or both.

17. The method of claim 15, further comprising:
skipping one or more respective transmission occasions associated with the two or more semi-persistent scheduling configurations, wherein the one or more respective transmission occasions are skipped based at least in part on a skipping indication included in the first control message.

18. The method of claim 15, further comprising:
adding one or more respective transmission occasions associated with the two or more semi-persistent scheduling configurations, wherein the one or more respective transmission occasions are added based at least in part on an indication included in the first control message, and wherein the one or more respective transmission occasions are used for communicating with the UE.

19. The method of claim 15, further comprising:
shifting one or more respective time resources, one or more respective frequency resources, or both, associated with the two or more semi-persistent scheduling configurations, wherein the one or more respective time resources, the one or more respective frequency resources, or both are shifted based at least in part on an indication included in the first control message, and wherein the one or more respective time resources, the one or more respective frequency resources, or both, that are shifted are used for communicating with the UE.

20. An apparatus for wireless communications at a user equipment (UE), comprising:
a processor;
memory coupled with the processor; and
instructions stored in the memory and executable by the processor to cause the apparatus to:
receive a first control message indicating one or more uplink semi-persistent scheduling configurations and one or more downlink semi-persistent scheduling configurations;
receive a second control message activating two or more semi-persistent scheduling configurations of the one or more uplink semi-persistent scheduling configurations, or the one or more downlink semi-persistent scheduling configurations, or both, wherein the two or more semi-persistent scheduling configurations that are activated are associated with one or more component carriers; and
communicate with a network entity based at least in part on the two or more semi-persistent scheduling configurations that are activated.
